(19) United States
(12) Patent Application Publication
(10) Pub. No.: US 2002/0166924 A1
(43) Pub. Date: Nov. 14, 2002

(54) Methods and apparatus for canopy fragilization

(76) Inventor: Wm. David Fahey, Cupertino, CA (US)

Correspondence Address: WILSON SONSINI GOODRICH & ROSATI, 650 PAGE MILL ROAD, PALO ALTO, CA, 943041050

(21) Appl. No.: 10/141,542

(22) Filed: May 7, 2002

Related U.S. Application Data
(60) Provisional application No. 60/289,636, filed on May 8, 2001.

(51) Int. Cl. B64C 1/10; B64D 7/00

(52) U.S. Cl. 244/121

(57) ABSTRACT

A canopy fragilization system comprising an ordnance-free breakable canopy for aircraft and other transport vehicles. A breakable portion of the canopy includes embedded wiring that is installed along selected portions of the canopy to be cut out or fragilized in a desired pattern. A flux compression generator (FCG) is located on board the vehicle to power the fragilization system wherein an electrical surge is generated by the FCG during an ejection sequence. The electrical surge generated by the FCG is delivered through an electrically conductive cable to the wired canopy thereby fragilizing and structurally weakening the canopy. Methods and apparatus are further provided for fragilizing an aircraft canopy by delivering an electrical surge from a compact FCG to a pre-wired canopy. The pre-wired canopy may incorporate a dual-wiring configuration wherein pairs of linear or non-linear wires run substantially parallel along a breakable portion of the canopy to cut or fragilize the covering in a predetermined pattern.

This application claims the benefit of the United States Provisional Patent Application Serial No. 60/289,636 filed on May 8, 2001, which is incorporated by reference in its entirety herein.

### FIELD OF THE INVENTION

The invention relates to methods and apparatus for fragilization of canopies and vehicle coverings or panels. More particularly, the invention relates to canopy fragilization systems powered by flux compression generators.

### BACKGROUND

Throughout the course of modem aviation, occupants of high speed aircraft have depended on safe and reliable ejection systems for emergency situations. An ejection seat or platform typically propels aircraft occupants out of and away from the aircraft at relatively high speeds. This rapid escape is often accomplished at appropriate trajectories so that personnel can avoid impact with the fuselage and other sections of the airplane while minimizing the effects from the sudden blast of air and pressure change. The occupants are intended to be thrown well clear of the abandoned aircraft which continues on or breaks up. A canopy must therefore permit rapid escape from the aircraft.

An aircraft canopy must be rapidly removed or otherwise opened in time for the safe ejection of personnel. There are numerous solutions and strategies available in removing or opening aircraft canopies. For example, an entire canopy may be opened or removed from the aircraft through common mechanisms similar to those used for jettisoning ejection seats. Additional time however is required with this approach since the entire canopy assembly must be thrown clear of the cockpit area to avoid a collision with the escaping flight crew. Alternatively, a relatively faster alternative to removing an entire canopy is to simply catapult an ejection seat or platform through a covering that is breakable. The ejection seat can fragment the canopy upon impact, but may also pose a significant risk of bodily injury to crew members who experience tremendous shock since they are directly attached to the ejected seats.

Another known solution is to destabilize or to create an opening in the aircraft covering prior to ejection through which seat assemblies and occupants can pass. The fragmentation or fragilization of the canopy may be achieved by various methods including the use of explosives or cutting cords. For example, an apparatus for cutting an opening in a cockpit canopy may involve the use of an explosive or cutting cord such as those described in U.S. Pat. No. 3,806,069. The opening created by detonating the cord allows passage through it for ejection seats and personnel. The requisite amount of explosive material needed to form an opening or to break apart the canopy may also require an undesirable bulky cord that could restrict pilot vision. Furthermore, the ensuing explosion could also injure cockpit occupants and spatter debris causing severe injury. Large cutting cords, when fired, also generate loud explosions which pose a high risk of hearing loss to crewmembers. The solution however of blasting open a portion of the canopy to pass through presents additional problems and challenges since these coverings are usually made of relatively strong materials to withstand direct impact with foreign objects. A highly loaded cutting cord with relatively large amounts of ordnance material is often needed to fragilize or fragment canopies formed of modem composite materials such as acrylic, stretched acrylic and polycarbonate materials. Moreover, the installation of cutting cords is a labor intensive process which may require up to approximately fifty hours to install under field conditions. Another related problem is that cutting cords contain high explosives that must be safely disposed of at the end of canopy life. In general, the service life of canopies overall vary and may require replacement during six-month to three-year cycles approximately. During each instance where the cutting cord or canopy is replaced, extreme care is required to safely dispose of the explosive materials which are bonded to the canopy. The cutting cords available today, some of which do not contain lead, may be also more expensive than the canopies themselves.

Alternatively, other methods and apparatus are available to fragment or fragilize canopies without explosive or cutting cords. U.S. Pat. No. 4,275,858, which is incorporated herein by reference in its entirety, describes panel breaking apparatus comprising a fusible electrical conductor arranged in contact with panel or canopy material. The conductor is connected to a source of electric power capable of producing a high energy pulse sufficient to explode the conductor or to create a hot plasma that fractures or cuts the panel. This patent describes fusible elements made of a metal having a low joule integral for melting. For example, tin was observed to have the lowest joule integral for melting, followed by nichrome, iron, eureka, zinc, lead, aluminum, silver, and copper in decreasing order. Preferably each element incorporates at least one point of reduced energy of fusion and is embedded in an aircraft cockpit canopy in a geometric pattern such that an area of the canopy in the vicinity of an ejection seat can be shattered by fusing the elements. At least one point of reduced energy of fusion may be realized by forming a sharp V-bend in the element, or a constriction, or preferably both with the constriction positioned at the apex of the V-bend. Other related panel breaking apparatus are also described in U.S. Pat. No. 4,405,104, which is incorporated herein by reference. In addition, more canopy fracture apparatus and systems are described in U.S. Pat. No. 3,806,069 which may comprise two sub-systems, one for shattering a canopy portion in the path or ahead of an ejection seat, and the other for detonating a miniature detonating cord to break the canopy away from its frame after a crash landing.

Prior canopy fragilization systems fail to provide safe, compact and reliable solutions that are economically viable. There is a need for compact on-board canopy fragilization systems that provide safer handling and lower maintenance costs.

### BRIEF SUMMARY OF THE INVENTION

The invention herein provides methods and apparatus for canopy fragilization that do not require the use of explosives in immediate contact with the canopy. The concepts of the invention may be applied to aircraft crewmember ejection systems where members are ejected through openings formed in the canopy. It shall be understood however that all aspects of the invention may be applied to any type of transport vehicle with a canopy or protective covering or any type of vehicle requiring separation, opening or cutting-apart of sections. The particular features of the described embodiments in the following specification may be considered individually or in combination with other variations and aspects of the invention.

It is an object of the invention to provide an aircraft cockpit canopy fragilization system that is powered with flux compression generator (FCG) power sources. An opening in a cockpit canopy may be formed by delivering an electrical surge generated by a FCG source through embedded canopy wiring or wires laid along defined portions of the canopy. The wiring may be laid onto an external panel surface or installed within the canopy during the manufacturing process. Upon delivery of the electrical surge from the FCG, the wired canopy is fragilized by the ensuing wire explosion action which rapidly cuts or breaks apart the covering. Additionally, an embedded wire configuration may further reduce noise or sound levels resulting from the wire explosion. A suitable wiring configuration and selection of FCGs with appropriate output levels may also assist in minimizing or preventing ejecta from the penetrating protective flight suits or otherwise injuring occupants of the vehicle. Other advantages of the fragilization methods and apparatus provided herein include elimination of explosive material or ordnance directly on the canopy or covering. This may provide significant life cycle cost savings and reduce environmental and safety issues. The electrically conductive wiring within canopy can also provide improved pilot vision as compared to bulkier and more obscuring or obstructive cutting cords.

Another object of the invention is to provide a wired canopy with a dual wiring configuration for connection to a compact high-power electrical source. A canopy formed with at least a portion with a dual wiring configuration may provide a more concentrated shock effect to the canopy than compared to a single wire pattern. As a result, less energy may be thus needed to fragilize or fragment the canopy and a more defined portion of the canopy may be destroyed in the process. In addition, parallel wiring techniques are described herein, including various wire configurations and geometries.

With respect to yet another aspect of the invention, methods are described herein to fragilize a breakable canopy that is pre-wired to receive a sudden surge of electrical energy from an FCG energy source. Although particular examples herein describe application of these methods and apparatus to canopies and vehicle coverings, it shall be understood that FCG energy sources may be selected for fragilizing or segmenting aircraft, rocket, automotive and spacecraft sections as may be desired for vehicle safety and segmentation of multistage transport vehicles.

Other objects and advantages of the invention will become apparent upon further consideration of the specification and drawings. While the following description may contain many specific details describing particular embodiments of the invention, this should not be construed as limitations to the scope of the invention, but rather as an exemplification of preferable embodiments. For each aspect of the invention, many variations are possible as suggested herein that are known to those of ordinary skill in the art.

### BRIEF DESCRIPTION OF THE DRAWINGS

FIG. 1 is a simplified illustration of a canopy fragilization system that includes a flux compression generator (FCG) in accordance with the invention.

FIG. 2 is a diagram of a solenoid FCG which may be incorporated into the canopy fragilization systems provided herein.

FIG. 3 is a series of illustrations depicting the detonation of an FCG energy source that can deliver an electrical surge to a canopy load.

FIG. 4 is an external perspective view of a compact on-board FCG that may be selected for aircraft canopy fragilization systems in accordance with the invention.

FIG. 5 is a simplified perspective view of a wired canopy connected to an FCG power source.

FIG. 6 is partial view of a series of wiring patterns that may be selected for canopy fragilization apparatus provided herein.

### DETAILED DESCRIPTION OF THE INVENTION

The invention herein provides methods and apparatus for fragilization of canopies and breakable vehicle coverings. A vehicle covering may be fragilized or structurally weakened in accordance with the invention by delivering a sudden electrical shock to a pre-wired canopy from a compact high-energy power source such as a flux compression generator (FCG). A vehicle occupant may be thus ejected and pass through the weakened covering in order to accomplish rapid emergency evacuation. It shall be understood that the apparatus and methods herein may be also modified to fragment or physically break apart vehicle coverings for certain applications described herein.

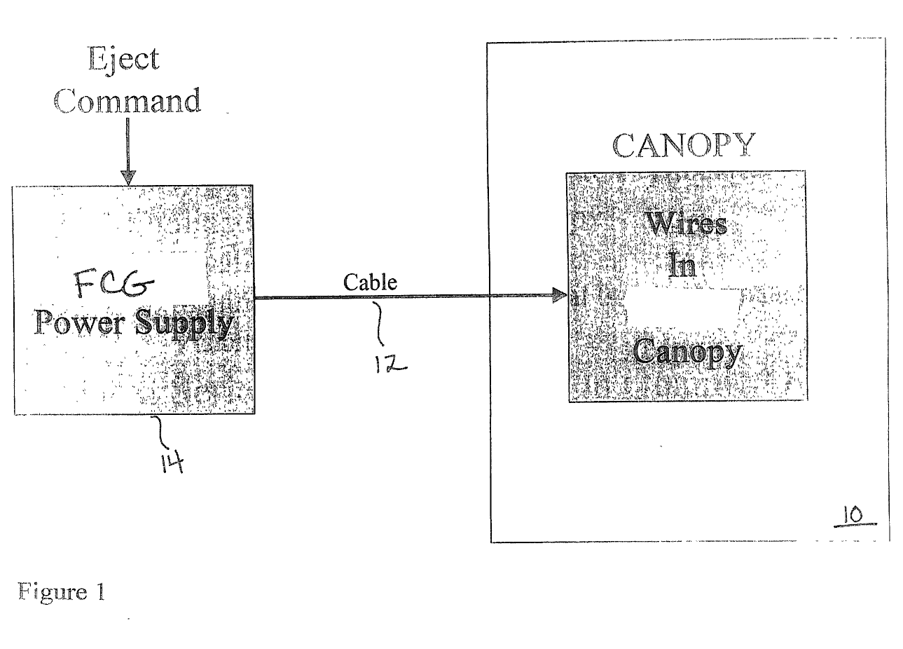

As shown in FIG. 1, the canopy fragilization systems herein include a canopy or vehicle covering 10 that is formed with electrically conductive wiring. Canopies or coverings herein may be formed of acrylic, polycarbonate, stretched acrylic or other conventional materials known to those of ordinary skill. The canopy wiring is connected by a cable or other electrical connection 12 to a flux compression generator (FCG) 14 in accordance with the invention. FCGs can provide an electrical surge sufficient to break apart the wired canopies described herein. An FCG is an astoundingly compact yet powerful energy source. While capable of delivering a preselected amount of energy needed to structurally weaken a canopy without seriously injuring personnel, these devices are available in relatively small packages which make them suitable for use on board an aircraft or other transport vehicle. The electrical surge delivered by FCGs herein are particularly suitable to drive relatively low-impedance loads such as the wired canopies herein. Under properly controlled conditions and within a contained environment, the power unleashed by an FCG can be harnessed to serve its intended purpose of fragilizing intended canopy portions without inflicting serious injury to occupants. This may be achieved by installing wires in or along canopy portions, and then running a rapidly rising high current through the wires from an FCG upon receiving an eject command. The wires in proximity to the canopy consequently explode or create a hot plasma thus generating a resultant shock or hot cutting plasma that breaks apart or fragilizes the canopy as explained in further detail herein. It shall be understood that other available compact high-power electrical sources may be selected for the on-board canopy fragilization systems herein. Other types of explosive driven electrical power sources may be selected in accordance with the invention which are otherwise known as explosive magnetic flux compressors and magneto-cumulative generators. While these and other similar devices are identified by various terms that are used interchangeably by those of ordinary skill in the field, the term “FCG” will be adopted herein without limitation for purposes of this description of the invention. It shall be further understood that the “non-explosive” aspect of the described canopy systems shall primarily refer to the wired canopy and other related portions of the invention other than the actual FCG component itself, which inherently relies upon a controlled explosion within a containment housing to generate the intended electrical surge.

Another aspect of the invention herein provides methods of fragilizing a canopy for an aircraft or transport vehicle by selecting an FCG power supply and a pre-wired canopy or covering. The canopy itself does not include ordnance or other forms of explosive material otherwise found in cutting cords. Prior to ejection from the aircraft, the system may be relatively passive in a standby mode. At the time of ejection sequence, the fragilization of the canopy may begin by sending the FCG power supply an eject command or other instruction to generate the resulting electrical surge to break apart the canopy. The FCG power supply may rapidly deliver a high current electrical surge at a relatively high voltage to the wiring and the pre-wired canopy thereby forming plasma along the wire length. As a result, the wiring embedded within or on the canopy surface explodes to fragilize the canopy as will be further described in detail below. The plasma formation and cracks or cuts to the canopy may be at least partially dependent upon the wiring size, canopy design and current generated by the FCG. The systems and methods provided by the invention can therefore variably cut a canopy or otherwise weaken the covering.

The canopy fragilization systems described herein operate with FCGs which fundamentally are compact high-power electrical sources. An FCG is a readily available power source that can quickly provide high energy and high current electric pulses. As an explosive actuated device, an FCG basically transfers the released energy stored within the chemical bonds of high explosives into concentrated electrical energy that gives rise to a relatively stronger and intensified magnetic field. The resultant energy is then delivered through conductive cable to the wired canopies herein as a relatively large amount of current at a relatively high voltage. While the amount of energy generated by the FCGs herein are not insubstantial, it is a relatively modest amount of energy and current output for these types of devices. FCGs have been known to generate energy output of up to hundreds of megajoules at millions of amperes which can serve as a type of electromagnetic bomb (also known as an “e-bomb”). More common applications however deliver several megajoules at hundreds of thousands amperes. The FCGs which may be selected for use with the canopy fragilization systems herein may generally provide about 25 KJ at several tens of thousand of amperes. Other suitable ranges may be selected for systems herein for fragilization of canopies or coverings with FCGs having outputs ranging from 5 to 50 kilojoules, and preferably about 10 kilojoules. These explosive devices can be often tested ahead of time with known computer modeling techniques. Modeling provides valuable test data and offers excellent prediction of device performance for certain applications. In some instances, actual model prediction for FCGs are reported to be within 10% of demonstrated performance. The power output of selected FCGs for use with the invention herein may be modified for particular applications under test conditions following acceptable modeling procedures.

While one of ordinary skill will understand how to implement the fragilization systems and methods herein with FCGs, the basic theory behind the operation of these devices shall be briefly described. In general, an FCG relies on an explosive force to compress a magnetic flux stored in an inductor into a region of relatively small inductance. Specifically, energy from an energy source or a capacitor charges the inductor, which is then compressed rapidly by detonating a surrounding explosive. During this process, the magnetic energy associated with the flux increases, which is inversely proportional to the inductance. Because of conservation of magnetic flux in the inductor, the inductor current sharply increases as its area and inductance decreases resulting from the explosion. The result is a large pulse of current that can be delivered to fragilize a canopy wired in accordance with the invention. This increase in flux and energy provides the energy gain and power output for the canopy systems herein.

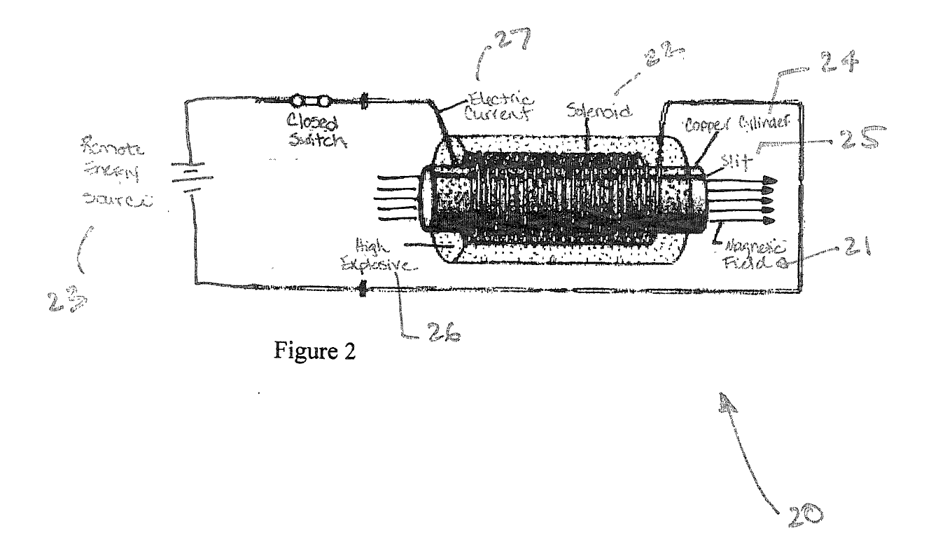

The invention may further incorporate other concepts relating to conventional FCG technology that are based on fundamental electromagnetic principles. For example, as shown in FIG. 2, a solenoid FCG 20 may be selected having a magnetic field 21 that is generated by passing current 27 through a coiled solenoid 22 from a remote energy source 23. As shown by the field pattern lines, the magnetic field 21 exists from one end of the coil 22 and circles around to the other end. The magnetic field lines may be drawn such that field strength is indicated by the density of lines (number of lines per unit area). The observed magnetic field strength decreases at greater distances away from the wire. Moreover, the magnetic field 21 includes a direction component which may be shown by applying what is known as the “right hand rule.” The thumb of a right hand points in the direction of the current flow when the fingers curl around the magnetic filed lines. It has been further observed that the magnetic field 21 created within the inner region of the solenoid 22 is relatively stronger and more uniform when compared to the relatively weaker and non-uniform field outside of the coil. As illustrated, the field pattern lines are more evenly spaced and denser within the solenoid region. It is known that magnetic flux ((D) is a product and property of magnetic field strength (B) and a defined surface area (A). In this example, the relevant surface area that defines the flux is represented by the cross-sectional area of the solenoid region encompassing a copper cylinder 24 formed with a slit 25. By rapidly imploding the cylinder or pipe 24 with high explosives 26 placed along its outer region to rapidly reduce its interior region cross-sectional area, the flux is thereby compressed and the density of flux lines increases. While the flux ideally remains constant or the same in accordance with conservation principles, the total magnetic field strength must therefore increase as the cross-sectional area of the solenoid 22 and pipe 24 decreases upon detonation of the surrounding high explosive 26 within the FCG 20. The FCG components described herein may be obtained from a variety of suppliers including Los Alamos National Laboratories (Los Alamos N.M.) and Lawrence Livermore National Laboratories (Livermore Calif.). For certain applications of the FCGs described herein, the solenoid may have an overall preferable length of approximately six-inches with an inner diameter of about 1-inch and an outer diameter of about 1½-inches. These and other solenoid parameters may also vary including the number of coils selected therein.

The simplified solenoid FCG 20 shown in FIG. 2 consists of an explosives-packed tube 24 placed inside a slightly larger copper coil or solenoid 22. The central copper or metal cylinder 24 in the solenoid 22 may be cut to form a long gap or longitudinal slit 25 substantially extending the length of the cylinder. In this initial configuration, the copper cylinder 24 does not provide a closed conducting surface so that current cannot circulate around its circumference. When a remote energy source 23 is connected to the copper coil 22, a current 27 runs through the coil, and an initial magnetic field is established inside of the cylinder 24. Before the chemical high explosive 26 is detonated as would be expected during an ejection sequence or fragilization procedure, the coil 22 is energized by a remote energy source or a source for creating a magnetic field such as magnets 23, thus creating the magnetic field. It has been observed that relatively low-voltage remote energy sources providing approximately 28V may be selected herein. The controlled firing of the high explosives 26 compresses the cylinder 24 which in turn closes the slit 25. The explosive charge 26 detonates from the rear forward, and as the tube 24 flares outward, it touches the edge of the coil thereby creating a moving short circuit. The propagating short has the effect of compressing the magnetic field while reducing the inductance of the stator coil. A closed surface is thus provided that conserves the generated flux while the magnitude of the magnetic field in the cylinder 24 rapidly increases. The FCG 20 ultimately produces a ramping current pulse which is transferred to wired in the canopy as described herein which begins to break apart and explode before the final disintegration of the FCG device.

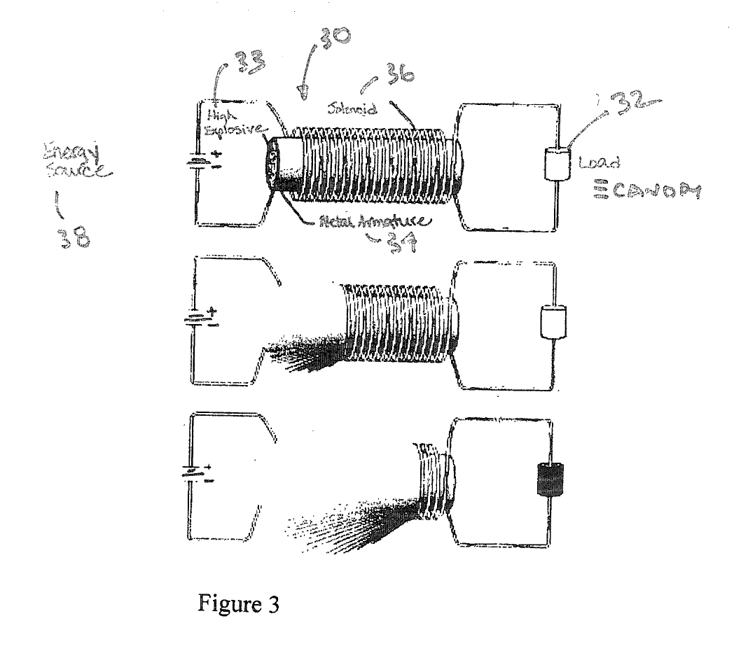

FIG. 3 is a series of illustrations depicting the detonation of a FCG energy source 30 that can deliver an electrical surge to a canopy load 32 in accordance with the invention. The illustrated helical FCG 30 may be substantially configured as those described above with the non-explosive canopy opening systems provided herein. A helical generator 30 may be selected with a long metal armature 34. The armature 34 itself may contain high explosives 33 and may be placed within an interior portion of the solenoid 36. When the energy source 38 is connected to the helical generator 30, the current generates a magnetic field in the space between the solenoid 36 and the armature 34. A circuit switch may be initially in the open position prior to an ejection sequence thereby preventing the current from flowing through the wired canopy or other designated load. The high explosives 33 may be ignited at one end by techniques known to those of ordinary skill, and the armature 34 may thereby expand accordingly much like inflating a long balloon. The existing volume of space between the surrounding solenoid 36 and the armature 34 thereby decreases in both the radial and longitudinal directions as the armature breaks apart. This causes the existing magnetic flux to be compressed as described herein, and an enhanced magnetic field is generated as a result of the decreased cross-sectional area in accordance with the principles of flux conservation. Accordingly, a large current is induced and carried in the remaining loops of the solenoid 36 which can be delivered to the selected load or wired canopy 32 and conductive cable assembles herein. It shall be understood that load switches and other known modifications to the described circuits may be modified in accordance with the invention to achieve particular results and goals with the detonation of FCG devices described herein.

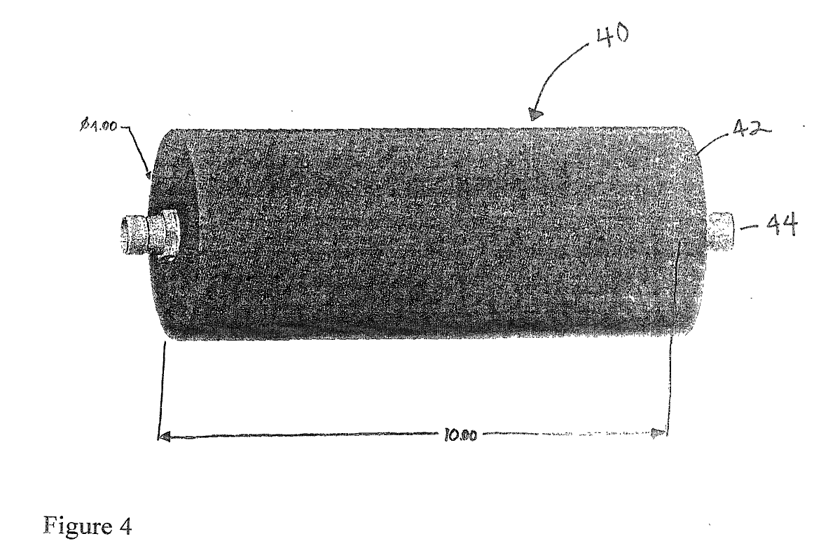

As shown in FIG. 4, a compact and explosively contained or controlled on-board FCG 40 may be selected for aircraft canopy fragilization systems in accordance with the invention. The use of FCGs with the canopy opening systems and methods herein are preferably carried out such that the resulting explosive energy is controlled and operated in a safe manner. The explosion may be contained within the FCG canister or structure 42 itself, or the device may be safely vented so that it does not present a hazard to aircrew members during ejection or to ground crew during escape sequences initiated external to the cockpit. The FCG housing 42 may be formed of suitable materials such as high strength metal alloys or steel, and may be further reinforced with other known materials or manufacturing processes. The housing 42 may further include outlets 44 leading to cables or wiring to transfer the electrical surge generated upon detonation of the high explosives therein. There are various types of known explosive materials for FCGs, and the relative amounts needed to generate a desired effect may be selected by those of ordinary skill. It shall be understood however that the type and amount of explosive material is dependent upon variables including the design of the selected FCG, the supplied input energy and the required energy output.

While the basic design of FCGs herein may be modified to provide the required energy needed to break apart wired canopies formed with different sizes and materials, a similar concern must be placed on containment of the explosion. Those skilled in the field of FCGs recognize both the benefits provided by this mature technology and the risks associated with containment as applied to the invention described herein. Other alternative containment solutions may be selected herein such as employing a mechanism to contain solid materials from the explosion or to convert the shock energy from the explosion to a different form of energy. In addition, energy may be safely vented from the FCG device which may redirect undesired residual energy as mentioned above. The ultimate size and weight of the package may dictate the type of and degree to which containment is needed for a particular FCG. For example, an FCG containment vessel may be selected measuring approximately three inches in diameter and eleven inches in length. The containment vessel which may be selected for such an explosive device may be formed with dimensions of approximately four to six inches in diameter and ten to thirteen inches in length. Of course these dimensions may vary according to containment requirements which depend upon the relative explosive power of a FCG contained therein.

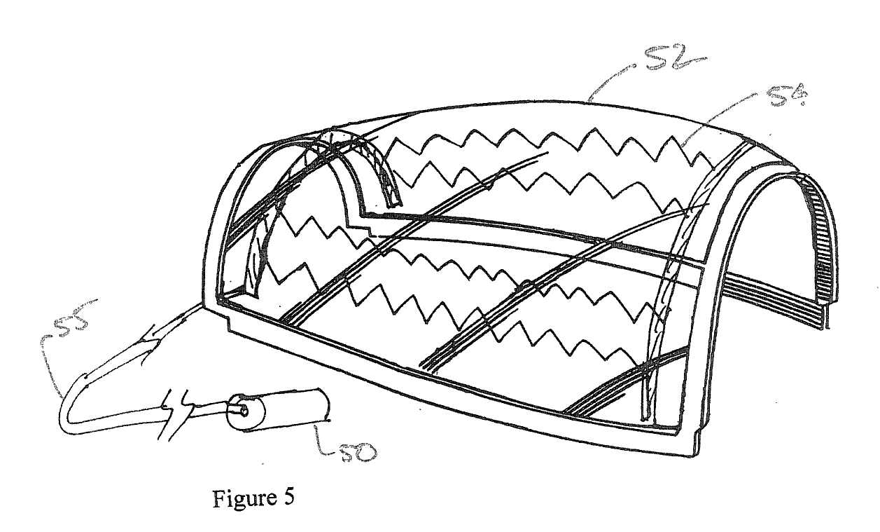

FIG. 5 illustrates an FCG power source 50 connected to a wired canopy 52 in accordance with the invention. As explained herein, the invention accomplishes canopy breaking or fragilization with a wired canopy 52 that does not contain explosives itself. An FCG unit 50 may be connected by a cable 55 to the wired non-exploding canopy 52 and installed at various locations away from the cockpit in a suitable location within the aircraft. This eliminates the need for the handling of ordnance and explosives directly mounted onto a canopy. Many other advantages are provided including the relatively lower noise levels generated by embodiments of the invention having embedded wiring since the explosive action takes place within canopy itself rather than on the surface thereof. The invention further provides a relatively lower cost alternative to explosive loaded canopies. The canopy wiring may be installed by canopy manufacturers and would not require installation by field personnel. The canopy fragilization systems described herein also eliminate ordnance disposal issues when a canopy is changed since there is no ordnance placed directly in contact with the canopy. Furthermore, the field of vision for crew member may be improved and less impaired by selecting wiring 54 that is relatively smaller in diameter than cutting cords. The canopy wiring 54 can also be tested periodically during maintenance and safety inspections with measuring devices such as ohm meters. It shall be understood that canopies formed of different materials and with different configurations may require FCGs with varying degrees of output in accordance with the invention. The wired canopies described herein may be tested with various wiring patterns and FCG devices to provide safe and effective fragilization systems.

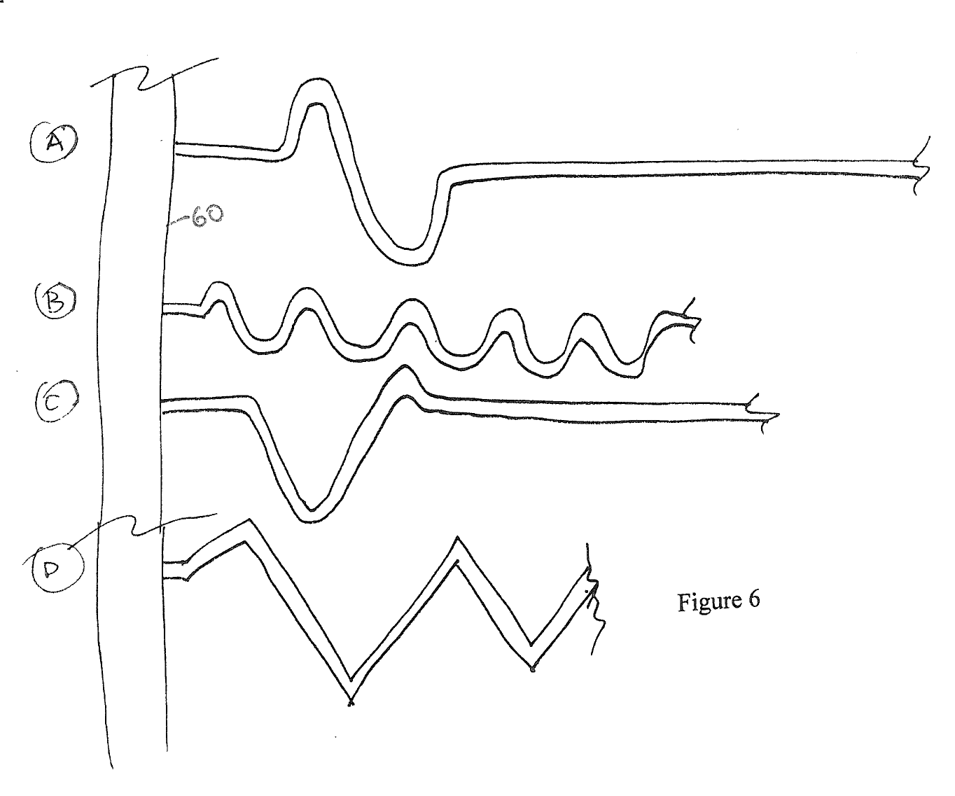

As shown in FIG. 6, the non-explosive canopies herein may be formed with a wide variety of wire patterns (A-D). The wiring pattern may include a straight wire or linear design, and may also include one or more sinusoidal-type curves (A-B). Similarly, the wiring in or along the canopy may be formed with relatively sharp bends along selected portions of a straight wire or continuously in a zig-zag pattern (C-D). The series of linear and non-linear wiring patterns shown are only representative of available configurations and shall not be construed in a limiting sense. While the wire illustrations are grouped in close proximity to each other and with different patterns with a common wiring band or element 60, it shall be understood that one or more patterns may be selected for a single canopy or vehicle covering and spaced apart as may be desired. More specifically, another embodiment of the invention herein provides a canopy formed with a dual-wiring configuration. A dual wiring configuration has been observed to enhance or multiply the effects of the current surge to the canopy. By placing two or more wires relatively close together in or along the canopy (any combination of A-D), the wired canopy configuration herein can multiply the resultant shock otherwise available from a single wire. As a result, the amount of firing energy from an FCG device can be thereby reduced to minimize the risk of injury and manufacturing costs. Other wire configurations may be applied in accordance with the invention to provide well defined cutting patterns for the canopies, coverings or other vehicle sections as described herein.

Various types and sizes of wiring may be selected for the canopies provided herein. For example, the wire size in the canopy may be preferably 0.36 mm and 0.45 mm for certain applications. In certain test canopies, 0.45 mm wiring may be particularly suitable. Nevertheless it shall be understood that the size, length and layout of the wiring within or on the canopies herein shall vary according to specific applications. The type of FCG and canopy material or size selected may affect the selection of wiring for the non-explosive canopies herein. Wire gauge sizes or diameters may range from about 0.1 mm to 1 mm. It shall be further understood that round electrical copper wires may be selected for the pre-wired canopies herein. But wiring formed of other electrically conductive materials with different shapes may be selected. The wiring installed onto the canopy or within the canopy may be also flat wire, braided wire or notched depending on particular applications.

While the invention has been described with reference to the aforementioned specification, the descriptions and illustrations of the preferred embodiments herein are not meant to be construed in a limiting sense. It shall be understood that all aspects of the invention are not limited to the specific depictions, configurations or relative proportions set forth herein which depend upon a variety of conditions and variables. Various modifications in form and detail of the embodiments of the invention, as well as other variations of the invention, will be apparent to a person skilled in the art upon reference to the present disclosure. It is therefore contemplated that the appended claims shall cover any such modifications, variations or equivalents of the described embodiments as falling within the true spirit and scope of the invention.

What is claimed is:

1. A canopy fragilization system comprising:
an ordnance-free canopy for a transport vehicle formed with a breakable portion, wherein the canopy includes wiring embedded within the canopy laid out in a preselected pattern to cut the canopy;
an electrically conductive cable connected to the canopy wiring; and
a compact flux compression generator (FCG) power source configured for operation within an aircraft connected to the electrically conductive cable to selectively deliver an electrical surge carried by the electrically conductive cable to the canopy thereby fragilizing and structurally weakening the canopy.

2. The canopy fragilization system of claim 1
wherein the compact FCG includes a containment housing for containing contents of the FCG when detonated to deliver the electrical surge.

3. The canopy fragilization system of claim 2
wherein the containment housing is formed with a substantially cylindrical outer configuration having a length of approximately 10 inches and a diameter of 4 inches.

4. The canopy fragilization system of claim 1
wherein the wiring embedded within the canopy includes at least one wire formed with a substantially linear portion and a substantially non-linear portion.

5. The canopy fragilization system of claim 1
wherein the wiring embedded within the canopy includes at least one pair of substantially parallel wires.

6. A method of fragilizing an aircraft canopy comprising the following steps of:
selecting a flux compression generator (FCG) power supply with a preselected power output that is formed with a command port for communication with an on-board ejection system, and a cable port for communication with an electrically conductive cable;
selecting a ordnance-free aircraft canopy formed with a preselected wiring configuration that is connected to the electrically conductive cable; and
directing the on-board ejection system to deliver a command signal to the FCG power supply to initiate an electrical discharge to the electrically conductive cable and aircraft canopy to thereby fragilize and structurally weaken the canopy.

7. The method of fragilizing an aircraft canopy as set forth in claim 6
wherein the preselected wiring configuration for the canopy includes at least one pair of electrically conductive wires running substantially parallel along a breakable portion of the canopy.

8. The method of fragilizing an aircraft canopy as set forth in claim 6 further comprising the step of
forming a hot plasma along at least a portion of the preselected wiring configuration of the canopy resulting from delivery of the electrical discharge from the FCG power supply.

9. The method of fragilizing an aircraft canopy as set forth in claim 6 further comprising the step of
exploding at least a portion of the preselected wiring configuration in the canopy resulting from delivery of the electrical discharge from the FCG power supply.

10. The method of fragilizing an aircraft canopy as set forth in claim 6 further comprising the step of:
installing the FCG power supply at a location on the aircraft remote from a cockpit portion thereof to reduce the impact of the detonation of the FCG to occupants in the cockpit portion.

11. An aircraft canopy fragilization system comprising:
an ordnance-free aircraft canopy formed with a breakable portion, wherein the canopy includes wiring laid out along the breakable portion of the canopy in a preselected dual-wiring pattern to cut the canopy;
an electrically conductive cable connected to the canopy wiring; and
a compact flux compression generator (FCG) power source in communication with the electrically conductive cable, wherein the FCG is configured for operation within an aircraft to selectively deliver an electrical surge carried by the electrically conductive cable to the canopy wiring laid out in the preselected dual-wiring pattern to thereby fragilizing and structurally weakening the canopy.

12. The aircraft canopy fragilization system of claim 11
wherein the canopy wiring is at least partially embedded along a breakable portion of the canopy.

13. The aircraft canopy fragilization system of claim 11
wherein the dual-wiring pattern includes wires formed with at least a portion having a generally zig-zag pattern.

14. The aircraft canopy fragilization system of claim 11
wherein the dual-wiring pattern includes wires formed with at least a portion having a generally sinusoidal-type pattern.
